(19) United States
(12) Patent Application Publication
(10) Pub. No.: US 2021/0226822 A1
(43) Pub. Date: Jul. 22, 2021

(54) Device for Receiving Signals from a Network Cable

(71) Applicant: PEPPERL + FUCHS GMBH, Mannheim (DE)

(72) Inventors: Steffen Graber, Mannheim (DE); Dirk Ziegelmeier, Mannheim (DE)

(73) Assignee: PEPPERL + FUCHS GMBH, Mannheim (DE)

(21) Appl. No.: 16/309,829

(22) PCT Filed: Jul. 12, 2018
(86) PCT No.: PCT/EP2018/068979

§ 371 Date: Dec. 13, 2018

(30) Foreign Application Priority Data
Aug. 22, 2017 (GB) 1713460.2

(51) Int. Cl. H04L 25/03; H04L 12/24; G06K 9/62

(52) U.S. Cl. CPC H04L 25/03019; H04L 25/03878; H04L 2025/03732; G06K 9/6256; H04L 41/0853

(57) ABSTRACT

There is provided a device comprising a channel equalizer and a monitoring device, wherein the device is configured to establish a point-to-point network connection with a connected device via a network cable, by executing an initial training cycle so data received via the network cable is readable by the device. The channel equalizer is configured to continuously adapt to characteristics of the network cable by continuous training of the channel equalizer to help maintain the network connection, and the monitoring device is configured to monitor signals received from the network cable for out-of-range signals, to temporarily interrupt the continuous training of the channel equalizer when out-of-range signals are detected, and to resume the continuous training once the out-of-range signals are no longer detected without executing the initial training cycle again.

### FIELD OF THE INVENTION

The present invention relates to a device for receiving signals from a network cable, the device comprising a channel equalizer and a monitoring device.

### BACKGROUND OF THE INVENTION

Wired networks such as Ethernet typically comprise a plurality of devices connected to one another by network cabling. Signals are sent to the devices via the network cabling, and need to be correctly decoded into meaningful data. The electrical characteristics of the network cabling as seen by each device varies depending upon the type and configuration of the network cabling and the other device(s) connected via the network cabling.

Once the devices are connected to one another via network cabling and powered up, the devices establish network connections with one another by executing initial training cycles so that data sent by each device can be correctly read by another device. For example, it is known to provide devices with channel equalizers which are trained to compensate for the electrical characteristics of the network cabling, so that the effect of the electrical characteristics of the network cabling on the frequency spectrum of the transmitted signals is substantially reversed at the device and the transmitted signals can be correctly decoded at the device. It is also known to provide bit scramblers, which require the scramblers at the transmitting and receiving devices to be synchronised with one another so that the scrambling performed at the transmitting device is correctly reversed at the receiving device. Clock synchronisation between the transmitting and receiving devices also needs to be performed, and so the initial establishment of the network by performing an initial training cycle can take a significant length of time.

If the network connection to a device is disrupted, for example by electrical interference, then the device has to perform the initial training cycle all over again to re-establish the network connection. This is disruptive for a process control network, due to the loss of expected process control communication and process monitoring, which would lead to audio/visual alarm annunciation, or a possible system shut-down.

It is also known to continuously train the channel equalizers of the devices during the operation of the network, in addition to the training that is performed as part of the initial training cycle. This continuous training is useful since it allows the device to adapt to changes in the electrical characteristics of the network cabling, for example due to changes in temperature or humidity, or due to changes in the devices connected to network cabling. However, the ability of the channel equalizers to adapt to these changes through training opens up the risk of training towards an unstable operating state when the network cabling is subjected to short-lived events such as current/voltage transients seen when connecting or disconnecting devices or switches to/from the network, or due to electrical interference in harsh EMC (electromagnetic compatibility) environments. Then, the whole network may need to be re-started, interrupting all the ongoing data transfers over the network and introducing a long delay before communications can be restarted.

The Power over Data Line system, for example as standardised in IEEE 802.3bu™ in 2016, defines an Ethernet system in which both power and data can be sent in differential mode over a single twisted pair of conductors at the same time as one another. A power source equipment is used to provide the power to powered devices via the network cabling, the powered devices being able to receive data signals over the same network cabling on which the power is sent. Changing the devices connected to the network, for example by adding or removing devices, changes the power drawn from the power source equipment. Since both power and data are sent in differential mode over a balanced pair of conductors, for example a twisted pair of conductors, changes in the power flowing through each twisted pair of conductors can affect the data that is being sent along the balanced pair of conductors. Accordingly, the addition of power to the network cabling increases the scope for changes in the network cabling or connected devices to cause signal disturbances that train the channel equalizers of the powered devices into failure, necessitating interruption of the ongoing data transfers and re-starting of the network with the associated long delay.

In point-to-point network connections comprising two devices connected by a network cable, a master one of the devices generates the clock and a slave one of the devices recovers the clock from the data signals. Both devices may comprise echo cancellers in addition to the channel equalizers to cancel out echoes from the signals they send out, and the echo canceller of the master device in particular takes a long time to train during the initial training cycle to detect the clock phase of the data signals received back from the slave device.

It is therefore an object of the invention to improve upon the known art.

### SUMMARY OF THE INVENTION

According to a first aspect of the invention, there is provided a device comprising a channel equalizer and a monitoring device. The device is configured to establish a point-to-point network connection with a connected device via a network cable, by executing an initial training cycle so data received via the network cable is readable by the device. The channel equalizer is configured to continuously adapt to characteristics of the network cable by continuous training of the channel equalizer to help maintain the network connection. The monitoring device is configured to monitor signals received from the network cable for out-of-range signals, to temporarily interrupt the continuous training of the channel equalizer when out-of-range signals are detected, and to resume the continuous training once the out-of-range signals are no longer detected without executing the initial training cycle again.

Accordingly, transient events on the network may be detected by the monitoring device, and training of the channel equalizer suspended until the transient events have passed, to avoid training the channel equalizer into failure and having to re-start the network connection by executing the initial training cycle, which would take a relatively long time. Typically, the initial training cycle takes at least a second, whereas the transient events may be over as quickly as within a few milliseconds, and so pausing training of the channel equalizer until after the transients have passed can avoid the need to perform the initial training cycle again, greatly reducing the amount of time for which data transfer over the network cable is interrupted. Any received data which is corrupted due to a transient event may be detected and requested to be resent, for example according to conventional automatic-repeat-request (ARQ) protocols.

The temporarily interruption of the continuous training of the channel equalizer may comprise suspending the training of the channel equalizer for at least a fixed period of time before resuming training of the channel equalizer. The fixed period of time may be fixed as at least 10 ms, at least 20 ms, or at least 30 ms. The length of the fixed period of time is a compromise between how fast to restart the training and how long to wait to be able to assume that the disturbance is over, and in a Power-over-Data-Line system may be set depending on the time constant of the power and signal coupling network. Preferably, the fixed period of time runs from the most recent detection of out-of-range signals by the monitoring device, and the continuous training resumes as soon as the fixed period of time expires, provided that no further out-of-range signals have been detected by the monitoring device.

The channel equalizer may comprise a feed-forward equalizer, for example a fractionally spaced equalizer, and may also comprise a decision feedback equalizer. The device may periodically store the trained state of the channel equalizer as configuration settings, so that the most recently stored configuration settings can be used as a last-known-good state of the channel equalizer, and applied to the channel equalizer if needed to recover from signal disturbances. The configuration settings may for example comprise filter coefficients of an adaptive filter of the channel equalizer.

Preferably, the channel equalizer is configured to operate in a first training mode when the device is initialised to begin receiving the signals from the network cable during the initial training cycle, and to operate in a second training mode during normal data communications, wherein the configuration settings are modified in the second training mode at a slower rate than in the first training mode. Then, the channel equalizer quickly adapts to the characteristics of the network cable when the device is first turned on, so the device can quickly start receiving data, and more slowly adapts to the characteristics of the network cable during normal operation, so the equalizer is less likely to be trained into failure by short-duration transient events. The characteristics of the network cable change slowly, for example in synchronization with changes in temperature or humidity, and so a slow adaption to the characteristics of the network cable during normal operation is appropriate.

The device may comprise a clock recovery circuit to recover a clock signal from the data signals received from the network cable, so that a clock signal does not need to be sent separately or be independently generated at the device. The clock recovery circuit may comprise a Gardner phase detector coupled to a Proportional Integral controller, or use baud rate sampling and the Mueller-Müller clock recovery algorithm. The monitoring device may determine that out-of-range signals have been detected if the clock recovery circuit loses synchronisation with the clock signal, or if the output of the Proportional Integral controller starts to oscillate at a higher amplitude than a threshold amplitude.

The monitoring device may determine that out-of-range signals have been detected if the received signals are subject to repeated or prolonged disturbances in their normal operating ranges, for example if the voltage of the signal from the network cable exceeds a normal operating range. This could be detected as the voltage of the signal exceeding in-range voltage limits at an analogue to digital converter, an automatic gain controller, or a symbol slicer. A symbol slicer slices the received symbols to convert them into bits, as will be apparent to those skilled in the art.

The device may not receive any power from the network cable, for example in an unpowered Ethernet system, or may be configured to receive power, for example in a Power-over-Data-Line system where both power and data are sent together in differential mode over a single pair of conductors. The level of power drawn by the device may be constant to avoid corrupting the data. Typically, a direct current power signal may be inductively coupled to positive and negative ones of the pair of conductors, and data signals may be capacitively coupled to the pair of conductors. The word “constant” in relation to the level of power means “substantially constant”, or “constant to all intents of purpose”, so as to avoid corruption of the data. Very slight fluctuations or very slow changes in power level, for example current rate changes of 100 mA/ms or less, are so small as to have no practical effect on the data.

The device may be further configured to send signals over the network cable on the same pair of conductors used to receive the signals from the network cable, so the device can establish full duplex data connections via the network cable. Preferably, the device comprises an echo canceller to cancel echoes from the data it sends, out from the data that it receives.

Similarly to the channel equalizer, the echo canceller may be continuously trained to adapt to the characteristics of the network cable, and the continuous training may be interrupted when out-of-range signals from the network cable are detected by the device, until after the out-of-range signals have returned to within range. Preferably, the echo canceller is configured to operate in a first training mode when the device is initialised to begin receiving the signals from the network cable during the initial training cycle, and to operate in a second training mode during normal data communications, wherein the echo canceller is trained in the second training mode at a slower rate than in the first training mode. Then, the echo canceller quickly adapts to the characteristics of the network cable when the device is first turned on, so the device can quickly start receiving data, and more slowly adapts to the characteristics of the network cable during normal operation, so the equalizer is less likely to be trained into failure by short-duration transient events.

Alternatively, the device may use one pair of conductors for receiving data and another pair of conductors for sending data, to avoid the need for an echo canceller.

There is further provided a network system comprising the device, the connected device, and the network cable. Advantageously, the differential data signals may be constrained to the point-to-point network connection, whereas the differential power signal may originate from a further connected device that is remote from the connected device, so that the network only requires one power source to power all of the devices connected to the network. Multiple devices can then be linked together with point-to-point network connections in a daisy-chain configuration, with power being passed along the chain to power all the devices via the point-to-point network connections, whilst still preventing the differential data signals sent on each point-to-point network connection from interfering with one another. Star configurations are also possible. Each point-to-point data connection may for example be referred to as a spur connection or a trunk connection in the art, depending on the position of the segment in the overall network topology.

Two adjacent point-to-point network connections of the network may link to one another at a network field switch, where each network field switch comprises two devices including one device for each point-to-point network connection, and further comprises a digital device that passes data between the two devices to bridge between the adjacent point-to-point network connections. One of the two devices may draw the constant current or constant power to power both the two devices and the digital device. The constant current or constant power may also be used to power further devices of the network field switch, for example for connecting field devices into the network.

Each device may be referred to as a PHY, an abbreviation for the physical layer of the OSI model which refers to the circuitry required to implement physical layer functions of the network, as will be apparent to those skilled in the art. Typically, the PHY will form part of a larger device, for example a network field switch or a field device.

According to a second aspect of the invention, there is provided a method of adding or removing a device from a network system. The network system comprises a plurality of pairs of devices, and a power sourcing equipment for supplying power to the devices via network cables. The devices of each pair are configured to establish a point-to-point network connection with one another via an associated one of the network cables, by each device of the pair executing an initial training cycle so data received via the network cable is readable by the device. Each device comprises a channel equalizer and a monitoring device, wherein the channel equalizer is configured to continuously adapt to characteristics of the associated network cable by continuous training of the channel equalizer to help maintain the point-to-point network connection, wherein the monitoring device is configured to monitor signals received from the associated network cable for out-of-range signals, to temporarily interrupt the continuous training of the channel equalizer when out-of-range signals are detected, and to resume the continuous training once the out-of-range signals are no longer detected without executing the initial training cycle again. Each device is powered by a constant current or constant power drawn from the power sourcing equipment via the network cables, and the method comprises:

adding or removing one of the devices from the network system, thereby adding or removing the current or power drawn by that device, which causes a disturbance in the signals the other devices receive from their associated network cables;

detecting the disturbance as out-of-range signals at the monitoring devices of the other devices; and

temporarily interrupting the continuous training of the channel equalizers of the other devices in response to detecting the disturbance as out-of-range signals, and

resuming the continuous training of the channel equalizers of the other devices once the out-of-range signals are no longer detected without executing the initial training cycle again.

Accordingly, when a device is added or removed from the network system, changing the level of current flowing along the cables of the network cabling, signal disturbances resulting in out-of-range signals at any of the devices are detected, and training of the channel equalizers of the affected devices is suspended until the out-of-range signals have returned to within range.

### DETAILED DESCRIPTION

Embodiments of the invention will now be described by way of non-limiting example only and with reference to the accompanying drawings, in which:

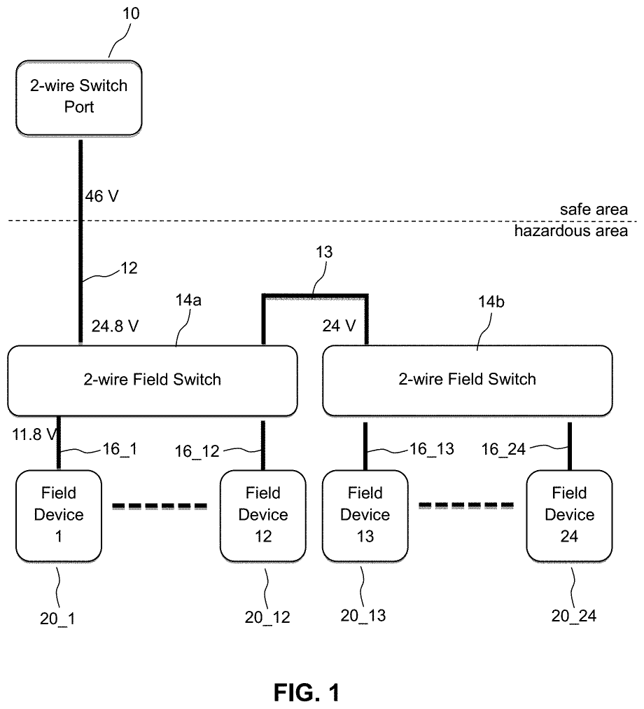

FIG. 1 shows a schematic diagram of a network system comprising multiple network cables and field devices connected by field switches, according to an embodiment of the invention;

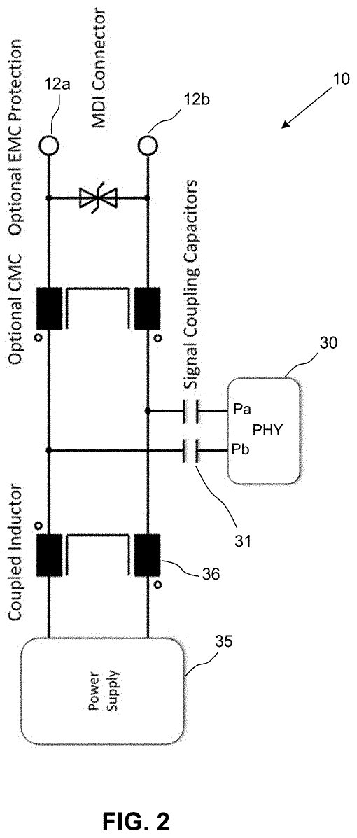

FIG. 2 shows a schematic circuit diagram of a 2-wire switch port for sending and receiving data to and from the network system via a pair of conductors of a network cable that carry both power and data;

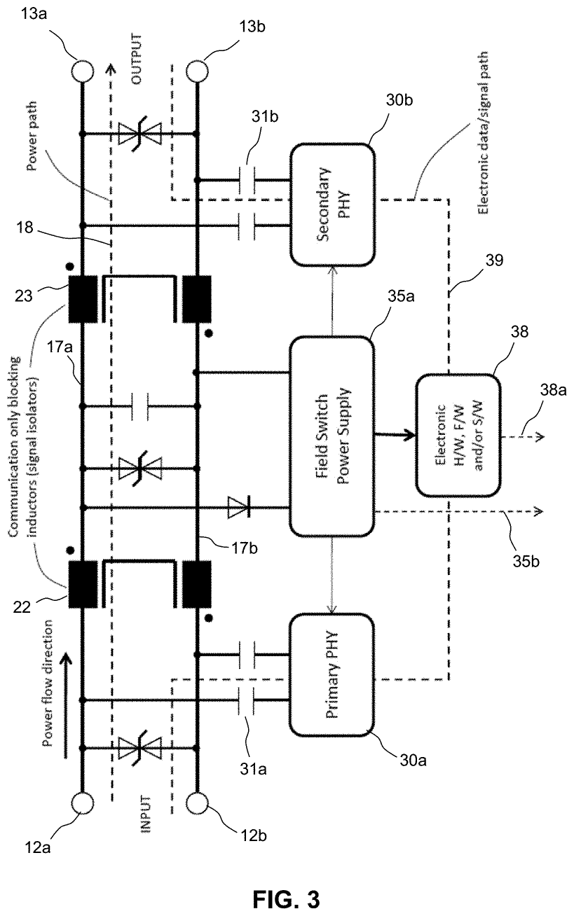

FIG. 3 shows a schematic block diagram of part of one of the field switches of FIG. 1;

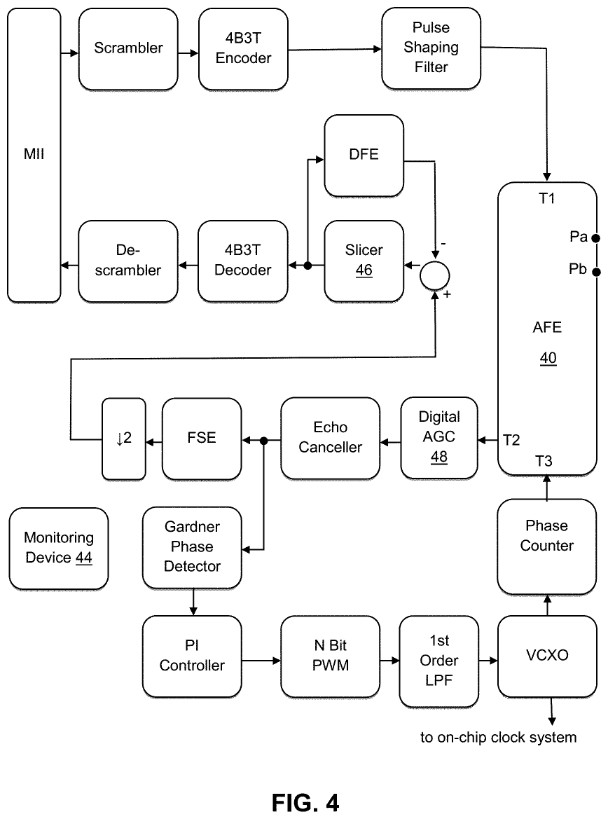

FIG. 4 shows a schematic block diagram of a PHY transceiver of the 2-wire switch port of FIG. 2;

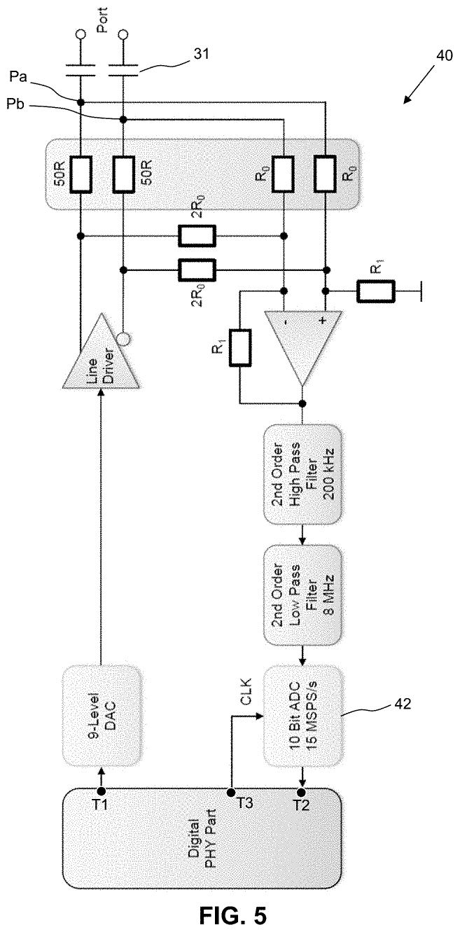

FIG. 5 shows a schematic block diagram of an analogue front end of the PHY transceiver of FIG. 4; and

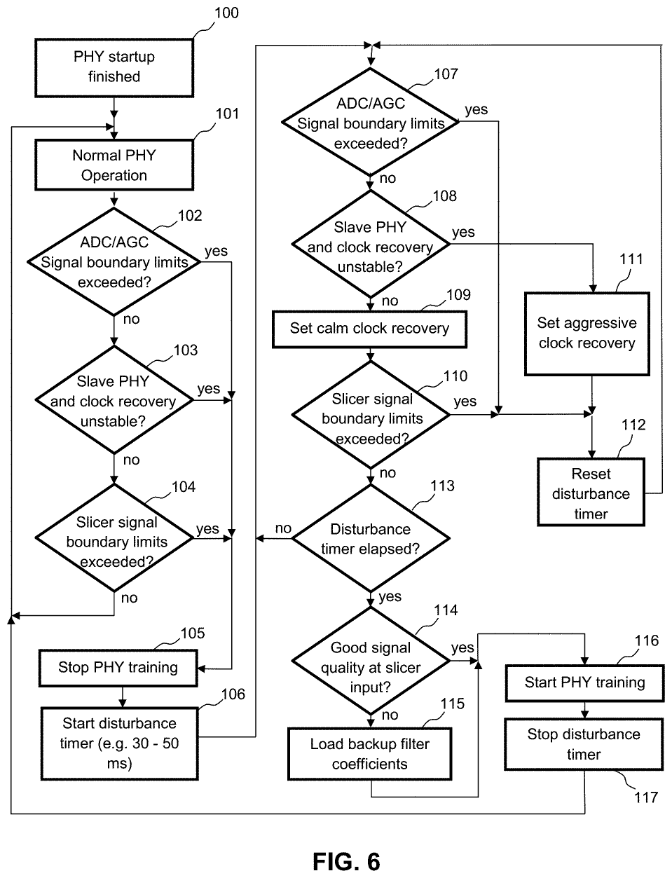

FIG. 6 shows a flow diagram of the operation of the PHY transceiver of FIG. 4.

The figures are not to scale, and same or similar reference signs denote same or similar features.

The schematic diagram of FIG. 1 shows a network system. The system comprises a 2-wire switch port 10 connected to a 2-wire field switch 14a by a network cable 12, and another 2-wire field switch 14b connected to the 2-wire field switch 14a by a network cable 13. Each of the 2-wire field switches 14a, 14b is connected to 12 field devices 20_1 to 20_24 by corresponding network cables 16_1 to 16_24. The network system allows communications to be passed between the 2-wire switch port 10 and the field devices 20_1 to 20_24, and between the field devices 20_1 to 20_24. The network system could easily be extended to include further field switches and field devices if required, as will be apparent to those skilled in the art.

The network system is built of multiple point-to-point network connections, so that the data communications on each network cable are only directly received by the two devices connected at either end of the network cable. For example, data sent along the network cable 12, does not pass directly to the cables 13 and 16_1 to 16_24 in a broadcast manner, but rather is received and read at the 2-wire field switch 14a, and is resent along the cables 13 or 16_1 to 16_24.

In this embodiment, each network cable comprises a twisted pair of conductors, and the data is sent along the pair of conductors in differential mode. The twisted pair of conductors constitute a balanced pair of conductors with a differential impedance of approximately 100 ohms and a symmetric impedance to ground of approximately 50 ohms per conductor, so that under EMC conditions there is only a low common mode to differential mode conversion, which provides good EMC immunity. The 2-wire switch port 10 forms one end of the network, and may for example be integrated within a host computer, and allow data communications to be directed to other networks or devices. The 2-wire switch port 10 also includes a power supply to supply the whole of the network system with power. The power is sent in differential mode along the pair of conductors of each network cable, along with the data signals. Since the power drawn from the power supply by the field switches and the field devices is substantially constant, the data signals can be filtered out from the power being sent on each network cable. The differential power is passed between the network cables by the field switches.

The schematic diagram of FIG. 2 shows a block diagram of the 2-wire switch port 10 of FIG. 1. As shown, the 2-wire switch port 10 comprises a power supply 35 and a PHY transceiver 30, which are both connected to a pair of conductors 12a and 12b of the network cable 12 of FIG. 1. The power supply 35 supplies differential power across the pair of conductors 12a and 12b, so that it is transmitted to the 2-wire field switch 14a via the network cable 12. The power is subsequently passed to the 2-wire field switch 14b and the field devices 20_1 to 20_24 via the network cables 13 and 16_1 to 16_24, and is used to power the field switches and field devices. The mean power consumption of each field device 20_1 to 20_24 may for example be 250 mW.

The PHY transceiver 30 has two output contacts Pa and Pb for differential serial data, and the differential serial data is modulated onto the pair of conductors 12a and 12b via a pair of signal coupling capacitors 13. The differential serial data is isolated from the power supply 35 by a coupled inductor 36, which blocks high frequency signals. According, the differential serial data can modulate the voltage that is applied across the pair of conductors 12a and 12b by the power supply 35. The 2-wire switch port 10 also comprises optional common-mode rejection (CMC) and optional electro-magnetic (EMC) protection for the pair of conductors 12a and 12b.

The PHY transceiver 30 both sends data to and receives data from the network cable 12, using differential signalling over the pair of conductors 12a and 12b. The 2-wire field switch 14a comprises a similar PHY transceiver to the PHY transceiver 30 at the other end of the network cable 12, for sending and receiving data to and from PHY transceiver 30. Each PHY transceiver typically receives digital data from a digital device, and modulates and sends the digital data as differential serial data over the pair of conductors of the network cable 12.

The schematic diagram of FIG. 3 shows a block diagram of part of the 2-wire field switch 14a. The 2-wire field switch 14a is connected to the pair of conductors 12a and 12b of the network cable 12 at the opposite end of the network cable 12 from the 2-wire switch port 10. The 2-wire field switch 14a is also connected to a pair of conductors 13a and 13b of the network cable 13. As shown, the conductor 12a is connected to the connector 13a via a conductor 17a, and the conductor 12b is connected to the connector 13b via a conductor 17b.

The conductors 12a and 12b are connected to the conductors 17a and 17b by a coupled inductor 22 which blocks high-frequency signals, and the conductors 17a and 17b are connected to the conductors 13a and 13b by a coupled inductor 23 which blocks high-frequency signals. Accordingly, the conductors 17a and 17b are isolated from the differential serial data being sent on the network cables 12 and 13 by the coupled inductors 22 and 23, and no differential serial data can pass between the network cables 12 and 13 along the conductors 17a and 17b. Only the low-frequency differential power signal from the power supply 30 passes through the coupled inductors 22 and 23, from the network cable 12 to the network cable 13, as illustrated by the power path 18.

The conductors 12a and 12b are connected to a primary PHY 30a via a pair of capacitors 31a. The primary PHY 30a receives data sent from the PHY 30, and sends data to the PHY 30, via the network cable 12 and the pairs of capacitors 31 and 31a. Accordingly, the PHY's 30 and 30a implement a point-to-point network connection between the 2-wire switch port 10 and the 2-wire field switch 14a, via the network cable 12.

The conductors 13a and 13b of the network cable 13 are connected to a secondary PHY 30b via a pair of capacitors 31b. The secondary PHY 30b is similar to the PHYs 30 and 30a, and sends and receives differential serial data over the network cable 13, by modulating the differential serial data on top of the low-frequency differential power signal on the conductors 13a and 13b. The low-frequency differential power signal is preferably a direct current signal, to avoid disturbing the data being sent on the conductors.

To transfer communications between the network cables 12 and 13, the PHYs 30a and 30b are both connected to a digital device 38, which passes digital data that is addressed to the field devices 20_13 to 20_24 from the network cable 12 to the network cable 13. The path of this digital data is illustrated as path 39, extending from the network cable 12, through the PHY 30a, the digital device 38, and the PHY 30b, and to the network cable 13.

The digital device 38 also comprises an output 38a, which receives and sends digital data from and to the field devices 20_1 to 20_12. The output 38a is connected to 12 additional PHYs of the 2-wire field switch 14a, which are not shown in FIG. 3 for the sake of clarity. These additional PHYs are similar to the PHYs 30, 30a, and 30b, and each additional PHY modulates the digital data onto a respective one of the network cables 16_1 to 16_12.

The 2-wire field switch 14a further comprises a power supply 35a, which is connected to conductors 17a and 17b, and draws a constant current or constant power from those conductors 17a and 17b. The power supply 35a uses that constant current or constant power to supply power to the primary PHY 30a, the secondary PHY 30b, and the digital device 38. The power supply 35a also has an output 35b which supplies power to the 12 additional PHYs (not shown in FIGS.) of the 2-wire field switch 14a and to the network cables 16_1 to 16_24. Since the power drawn by the power supply 35a is substantially constant, or only varies slowly, it does not normally modulate any differential signals onto the conductors 17a and 17b that could pass through the coupled inductors 22 and 23 to disrupt the differential serial data on the network cables 12 and 13. The 2-wire field switch 14b is similar to the 2-wire field switch 14a, and has PHYs similar to the PHYs of the 2-wire field switch 14a, for connecting to the network cables 13 and 16_13 to 16_24. The field devices 20_1 to 20_24 each have a PHY similar to the PHY 30a for communicating with the additional PHYs of the 2-wire field switches 14a and 14b via the network cables 16_1 to 16_24.

To avoid disrupting the serial differential data, the power (current) drawn by each 2-wire field switch 14a or 14b is required to be relatively constant compared to the frequency of the serial data. For example, any changes in current drawn by the 2-wire field switch 14a or 14b may be required to be at a rate of less than 100 mA/ms, so the changes can easily be filtered out from the data. To help achieve this the, the power (current) drawn by each field device 20_1 to 20_24 may be required to change at a rate of no faster than for example 10 mA/ms. But, if one of the field devices 20_1 to 20_12 was suddenly disconnected from the 2-wire field switch 14a, then the power being delivered to that field device via the associated network cable would suddenly cease, and there would be a sudden change in the power being drawn from the conductors 17a and 17b by the power supply 35a, possibly disrupting the differential serial data being sent on the network cables 12 and 13. The differential serial data being sent on the associated network cables 16_1 to 16_12 of the still-connected ones of the field devices 20_1 to 20_12 may also be affected. The same problem can occur if there is a sudden increase in power due to the disconnected field device being re-connected again. To help combat this problem, the PHYs may be configured to avoid executing an initial training cycle when the differential serial data is disrupted, as will be hereinafter described.

The schematic diagram of FIG. 4 shows a block diagram of the PHY 30, however this block diagram equally applies to the PHYs 30a and 30b, the 12 additional PHYs of the 2-wire field switch 14a, the PHYs of the 2-wire field switch 14b, and the PHYs of the field devices 20_1 to 20_24. As shown in FIG. 4, the PHY comprises an analogue front end (AFE) 40 which has two connections Pa and Pb, also designated on FIG. 2. These connections modulate differential serial data onto the network cable 12 via the pair of capacitors 31, and receive differential serial data from the network cable 12, in full duplex.

The AFE 40 has an input T1 for receiving digital data that is to be sent on the network cable 12, an input T3 for receiving a clock signal, and an output T2 for signals received from the network cable 12. An example of the AFE 40 is shown in FIG. 5, in which the connections to Pa, Pb, T1, T2, and T3 are all designated. It can be seen that input signals from the connections Pa and Pb are converted into digital format by an analogue to digital converter 42, which provides the output T2.

The digital signals received from the network cable 12 at the output T2 are used by the digital parts of the PHY 30 to extract both a clock signal and the digital data sent by the PHY 30a of the 2-wire field switch 14a. Specifically, it can be seen in FIG. 4 that the digital signals pass through an automatic gain controller AGC 48, and an echo canceller EC, and then follow two separate paths, one for clock recovery and one for reading data. The clock recovery path comprises a Gardner phase detector, proportional integral controller PI, pulse width modulator PWM, low pass filter LPF, voltage controlled oscillator VCXO, and phase counter. A Mueller-Muller phase detector could be used in place of the Gardner phase detector if desired.

The data path comprises a feed-forward equalizer in the form of a fractionally spaced equalizer FSE, a symbol slicer 46 with a decision feedback equalizer DFE, a bit decoder 4B3T, and a descrambler. The symbol slicer 46 slices the received digital values into symbols of either −1, 0, or +1, and the 4B3T decoder converts these symbols to binary bits of 1 or 0. The descrambled bits pass to a media independent interface MII, to which a digital device can be connected for communicating over the network via the PHY 30. The general principles of operation of each of these blocks are known in the art, and will be apparent to the skilled person.

According to this embodiment of the invention, the PHY 30 further comprises a monitoring device 44, which is used to monitor the signals received from the network cable 12 at several points within the PHY 30 to determine whether any out-of-range signals have been received. The connections between the monitoring device 44 and these points are not shown in FIG. 4 for clarity, however in this embodiment the monitoring device 44 monitors the received signals at the output of the low pass filter LPF, the ADC 42 (see FIG. 5), digital AGC 48, and the symbol slicer 46.

Specifically, the input voltage to the ADC 42 (see FIG. 5) is monitored by the monitoring device 44, and if the input voltage exceeds a normal operating range, or even exceeds the maximum input range of the ADC so that the ADC is driven into saturation with an output of all zeros or all ones, then the monitoring device will determine that out-of-range signals have been detected.

The received signals are also monitored by the monitoring device 44 in a similar manner at the digital AGC 48 (see FIG. 4), and if the received signal exceeds a normal operating range, or even exceeds the maximum range of the AGC so that the AGC is driven into saturation with an output of all zeros or all ones, then the monitoring device will determine that out-of-range signals have been detected.

The received signals are also monitored by the monitoring device 44 at the symbol slicer. In this embodiment the input signal at the slicer typically ranges between digital values corresponding to −1.5V and +1.5V. If the digital values of the slicer input signal correspond to a signal level above for example 2V or below −2V, then the monitoring device 44 will determine that out-of-range signals have been detected.

The monitoring device 44 also monitors the output of the low-pass filter LPF. Normally, the low-pass filter output varies slowly and with low amplitude, tracking any changes in the clock phase. But, if the low-pass filter output varies more quickly or with high amplitude, then this indicates that the PHY 30 is struggling to keep track of the clock phase, and the monitoring device 44 will determine that out-of-range signals have been detected.

In alternate embodiments, the monitoring device 44 may also monitor other points in the PHY 30 for out-of-range signals, or only monitor a selection of the four points discussed above in this embodiment. In any event, the monitoring device compares the received signal to an expected normal operating range, and determines that out-of-range signals have been detected when the received signal moves beyond the normal operating range.

The operation of the PHY 30 can be further appreciated with reference to the flow diagram of FIG. 6, which shows the operation of the PHY 30 when out-of-range signals are detected by the monitoring device 44. As shown in FIG. 6, the flow diagram begins with a step 100 where an initial training cycle has been completed to establish a network connection between the PHY 30 of the 2 wire switch 10 and the primary PHY 30a of the 2 wire field switch 30a. The initial training cycle includes training of the DFE and FSE channel equalizers and the echo canceller EC (see FIG. 4), as is commonly done in the art. The initial training cycle is necessary to establish the network connection between the PHYs 30 and 30a, so that data can be read from the signals received by the PHY 30.

Normal operation follows at step 101, in which the PHY 30 sends and receives data to and from various ones of the field devices 20_1 to 20_24, via the network connection between the PHY's 30 and 30a. The configuration settings of the DFE and FSE equalizers and the echo canceller EC of FIG. 4 are continuously trained in a second training mode to track any changes in the network link from the PHY 30 to the PHY 30a, for example due to temperature or humidity, as is known in the art. The continuous training in the second training mode takes place at a slower rate than the initial training which is done is a first training mode during the initial training cycle, since the continuous training is intended to track relatively slow changes in the network connection, for example due to changes in the temperature of the network cable.

Additionally, the configuration settings of the DFE and FSE equalizers and the echo canceller EC are periodically stored as backups, allowing them to be retrieved if necessary at a later time.

During normal operation, the monitoring device 44 monitors various points in the PHY 30 for out-of-range signals, including monitoring whether the received signal exceeds signal boundary limits at the ADC 42 or the AGC 48 in step 102, monitoring whether the output of the low pass filter LPF changes more quickly or with higher amplitude than its normal operating range in step 103, and monitoring whether the received signal exceeds signal boundary limits at the symbol slicer 104. If all those signals are within their normal operating ranges, then the PHY 30 loops back to step 101, and continues monitoring the various points in the PHY 30 for out-of-range signals.

If the monitoring device 44 determines that out-of-range signals have been received, then the PHY 30 moves to step 105, where the continuous training of the equalizers DFE and FSE and the echo canceller EC is stopped, so that the equalizers DFE and FSE and the echo canceller EC continue operating without further training their configuration settings. For example, if one of the field devices 20_13 to 20_24 shown in FIG. 1 is disconnected from the network, then the power being drawn to power that field device over the network cable 13 quickly ceases, causing a transient rise and fall in voltage across the conductors 13a and 13b. This transient passes through the coupling inductors 23 and 22 to the conductors 12a and 12b of the network cable 12 (see FIG. 3), and through the pair of capacitors 31 to the PHY 30 (see FIG. 2), where it moves the signal at the input of the ADC 42 (see FIG. 5) beyond normal operating range, which is detected by the monitoring device 44 as an out-of-range signal. A new field device being connected, or an EMC noise event, could have a similar effect. It will be appreciated that whilst in this embodiment the continuous training of all three of the DFE, FSE, and echo canceller EC is stopped, in alternate embodiments only the continuous training of one of the equalizers may be stopped, for example the continuous training of the DFE, especially in implementations where the PHY 30 does not have any FSE.

Once the continuous training has been stopped, the PHY 30 moves to step 106 where a disturbance timer is set to start running. The monitoring device 44 of the PHY 30 checks whether the received signal is still out-of-range in steps 107, 108, and 110, similar to steps 102, 103, and 104 described further above. If the received signal is still out-of-range, then the disturbance timer is re-set, causing it to start running again from zero. If the received signal has returned to within range, then the disturbance timer is checked in step 113, and if it has fully elapsed then the PHY 30 moves to step 114. Otherwise, the PHY 30 loops back to step 107 and continues to check for out-of-range signals. Accordingly, the flow diagram requires the received signal to remain within normal operating range for the duration of the disturbance timer, before the PHY moves on to the next step 114 and the continuous training is restarted. In this embodiment, the disturbance timer is set to run for 30 ms, however longer periods of time could be set if desired to provide more time for the received signals to properly settle before the continuous training begins again.

The result of checking for out-of-range signals at the low pass filter LPF in step 108 is used to set either aggressive or calm clock recovery settings. If out-of-range signals are present at the LPF, then this indicates the PHY 30 is struggling to maintain synchronisation with the clock, and so the PI controller is set with more aggressive convergence parameters to more aggressively converge towards the clock signal in step 111 to help prevent the clock synchronisation from being lost. If no out-of-range signals are present at the LPF, then this indicates that the PHY 30 is still well locked on to the clock phase, and so the PI controller is set with less aggressive convergence parameters to converge less aggressively (calmly) towards the clock phase in step 109.

Once the disturbance timer has elapsed and the PHY 30 moves to step 114, the signal quality at the input of the symbol slicer 46 is checked in step 114. If the signal quality is sufficiently high, for example if the signal levels match the signal levels expected under good operating conditions, then it can be assumed that the signal disturbance detected by the monitoring device did not result in any excessively adverse effects on the configuration settings of the equalizers and echo canceller EC before the continuous training was stopped, and the PHY 30 resumes training of the configuration settings in step 116. If the signal quality is not sufficiently high, for example if the signal contains too much noise and so does not match the signal levels expected under good operating conditions, then it is possible that the configuration settings of the equalizers and echo canceller were trained in a direction towards failure prior to the out-of-range signals being detected by the monitoring device and the training being stopped. Accordingly, the last backup of the configuration settings that was stored during normal operation in step 101, is used to overwrite the current configuration settings of the equalizers and echo canceller, in step 115. Then, the PHY 30 resumes the continuous training starting from those backup configuration settings in step 116. In this embodiment, the configuration settings include for example the filter coefficients of the adaptive filter DFE. The disturbance timer is stopped in set 117, and then the PHY 30 returns to normal operation in step 101, until any out-of-range signals are detected by the monitoring device 44 again. The data transfers between the PHY 30 and the PHY 30a continue to take place throughout the whole process, and any data that is too corrupted by the out-of-range signals to be read is requested to be resent. Accordingly, there is very little interruption in the data transfer, and higher protocol layers of the OSI 7-layer model may not even be affected by the out-of-range signals, in contrast to known systems which typically reset entirely when out-of-range signals occur, with equalizers and/or echo cancellers being trained into failure, and an initial training cycle having to be performed to restart data communications.

In summary, there is provided a device configured to establish a point-to-point network connection with a connected device, which temporarily interrupts the continuous training of one or more of its channel equalizer(s) when out-of-range signals are received from the associated network cable, as defined in the appended claims. The device may for example comprise any one of the PHY device 30, the primary, secondary, and additional PHYs of the 2-wire field switches 14a and 14b, or the PHYs of the field devices 20_1 to 20_24, and may further comprise a power supply for drawing power from the associated network cable, for example the power supply 35a shown in FIG. 3.

There is also provided a network system comprising the device, as defined in the appended claims. If the device is considered to comprise the primary PHY and the power supply of the 2-wire field switch 14b (equivalent to the PHY 30a and power supply 35a of the 2-wire field switch 14a), then the connected device is the PHY 30b of the 2-wire field switch 14a, and the point-to-point network connection is established between those devices via the network cable 13. The PHY 30 of the 2-wire switch port 10 may be considered to be a further connected device, and the PHY 30a and power supply 35a of the 2-wire field switch 14a may be considered to be a still further connected device, with the further connected device and still further connected device establishing a further point-to-point network connection between them over the network cable 12. Data may be passed from the 2-wire field switch 14b to the 2-wire switch port 10 via the point-to-point and further point-to-point network connections, and via the digital device 38 of the 2-wire field switch 14a which passes data between the point-to-point and further point-to-point network connections.

The constant current or constant power drawn by the power supply of the device in the 2-wire field switch 14b is supplied from the further point-to-point network connection between the 2-wire field switch 14a and the further connected device (PHY 30), via the conductors 12a, 12b, 13a, 13b of the network cables 12 and 13. In contrast, the differential data signals sent on the further point-to-point network connection are constrained to that connection by the coupling inductor 22, and so do not pass to the point-to-point network connection between the 2-wire field switch 14a and 2-wire field switch 14b. In this manner, power can be distributed to all the devices in the network system, whilst keeping the data signals on each network connection constrained to that network connection.

Many other variations of the described embodiments falling within the scope of the invention will be apparent to those skilled in the art.

1-30. (canceled)

31. A device comprising a channel equalizer and a monitoring device, wherein the device is configured to establish a point-to-point network connection with a connected device via a network cable, by executing an initial training cycle so that data received via the network cable is readable by the device, wherein the channel equalizer is configured to continuously adapt to characteristics of the network cable by continuous training of the channel equalizer to help maintain the network connection, wherein the monitoring device is configured to monitor signals received from the network cable for out-of-range signals, to temporarily interrupt the continuous training of the channel equalizer when out-of-range signals are detected, and to resume the continuous training once the out-of-range signals are no longer detected without executing the initial training cycle again.

32. The device of claim 31, wherein the channel equalizer comprises a feed-forward equalizer or a decision feedback equalizer.

33. The device of claim 31, wherein the channel equalizer comprises configuration settings, and wherein the channel equalizer is configured to modify the configuration settings to perform the continuous training.

34. The device of claim 33, wherein the channel equalizer comprises an adaptive filter, and wherein the configuration settings comprise filter coefficients of the adaptive filter.

35. The device of claim 33, wherein the device is configured to periodically store the configuration settings of the equalizer, and upon the temporary interruption of the continuous training of the channel equalizer, to apply the configuration settings to the channel equalizer that were stored just before the out-of-range signals were detected.

36. The device of claim 33, wherein the channel equalizer is configured to operate in a first training mode during the initial training cycle that establishes the network connection, and to operate in a second training mode during the continuous training of the channel equalizer to help maintain the network connection whilst normal data communications are taking place, wherein the configuration settings are modified in the second training mode at a slower rate than in the first training mode.

37. The device of claim 31, further comprising a clock recovery circuit for recovering a clock signal from the signals received from the network cable, wherein the clock recovery circuit comprises a Gardner phase detector or a Mueller-Muller phase detector, and wherein an output of the phase detector is coupled to a Proportional Integral controller.

38. The device of claim 37, wherein the clock recovery circuit comprises convergence parameters defining how aggressively the clock recovery circuit converges to the clock signal, and wherein the device is configured to set the convergence parameters to more aggressive values if the clock recovery circuit loses synchronisation with the clock signal, and to less aggressive values once the clock recovery circuit regains synchronisation with the clock signal.

39. The device of claim 37, wherein the monitoring device determines that out-of-range signals have been detected if the clock recovery circuit loses synchronisation with the clock signal.

40. The device of claim 31, wherein the monitoring device determines that out-of-range signals have been detected if:
the signals are subject to repeated or prolonged disturbances in their normal operating ranges; or
a voltage of the signals from the network cable exceeds a normal operating range.

41. The device of claim 31, wherein the monitoring device determines that out-of-range signals have been detected if a voltage of the signals exceeds in-range voltage limits at an analogue to digital converter, an automatic gain controller, or a symbol slicer of the device.

42. The device of claim 31, wherein the temporary interruption of the continuous training of the channel equalizer comprises suspending the training of the channel equalizer for at least a fixed period of time before resuming training of the channel equalizer, wherein the fixed period of time runs from the most recent detection of out-of-range signals by the monitoring device.

43. The device of claim 42, wherein the fixed period of time is fixed as at least 10 ms, at least 20 ms, or at least 30 ms.

44. The device of claim 31, wherein the device is a two-wire Ethernet device.

45. The device of claim 31, wherein the device is comprised in a powered device which is powered by power drawn from the network cable.

46. The device of claim 31, wherein the signals comprise serial data received in differential mode from a pair of conductors of the network cable, wherein the device is configured to continuously draw a constant current or constant power in differential mode from the pair of conductors.

47. The device of claim 31, wherein the device is further configured to send signals over the network cable on the pair of conductors used to receive the signals from the network cable, wherein the device further comprises an echo canceller to cancel echoes from the sent signals, wherein the echo canceller is configured to continuously adapt to characteristics of the network cable by continuous training of the echo canceller, and to temporarily interrupt the continuous training of the echo canceller when out-of-range signals are detected, until after the out-of-range signals have returned to within range.

48. The device of claim 45, wherein the device is further configured to send signals over the network cable on the pair of conductors used to receive the signals from the network cable, wherein the device further comprises an echo canceller to cancel echoes from the sent signal, wherein the device is configured to draw the constant current or constant power from the pair of conductors via at least one inductor, and to send and receive the signals on the pair of conductors via at least one capacitor or via at least one additional inductor that is mutually coupled to the at least one inductor.

49. The device of claim 47, wherein the device is configured to periodically store configuration settings of the echo canceller, and upon temporarily interrupting the continuous training of the echo canceller, to apply the configuration settings to the echo canceller that were stored just before the out-of-range signals were detected.

50. A network system comprising the device of claim 46, the network system further comprising the connected device and the network cable, wherein the differential serial data signals are constrained to the point-to-point network connection, wherein the connected device is part of a network field switch, and wherein the differential constant current or constant power drawn by the device is supplied from a further point-to-point network connection between the network field switch and a further connected device via a further network cable, the further network cable having a pair of conductors on which both further differential serial data signals and the differential constant current or constant power are sent, the further differential serial data signals being constrained to the further point-to-point network connection.

51. The network system of claim 50, wherein the network field switch further comprises a still further connected device, the still further connected device comprising a further channel equalizer and a further monitoring device, wherein the still further connected device and the further connected device are configured to establish the further point-to-point network connection via the further network cable, by executing an initial training cycle so that data received via the further network cable is readable by the still further connected device, wherein the further channel equalizer is configured to continuously adapt to characteristics of the further network cable by continuous training of the further channel equalizer to help maintain the further point-to-point network connection, wherein the further monitoring device is configured to monitor signals received from the further network cable for out-of-range signals, to temporarily interrupt the continuous training of the further channel equalizer when out-of-range signals are detected, and to resume the continuous training once the out-of-range signals are no longer detected without executing the initial training cycle again, wherein the signals received from the further network cable comprise serial data received in differential mode from a pair of conductors of the further network cable, wherein the still further connected device is configured to continuously draw a constant current or constant power in differential mode from the pair of conductors of the still further network cable, and wherein the network field switch is configured to power the connected device by the constant current or constant power drawn by the still further connected device.

52. The network system of claim 51, wherein the network field switch comprises a digital device that is also powered by the constant current or constant power drawn by the still further connected device, and wherein the digital device is configured to transfer digital data between the connected device and the still further connected device.

53. A method of adding or removing a device from a network system, the network system comprising a plurality of pairs of devices, and a power sourcing equipment for supplying power to the devices via network cables,
wherein the devices of each pair are configured to establish a point-to-point network connection with one another via an associated one of the network cables, by each device of the pair executing an initial training cycle so data received via the network cable is readable by the device,
wherein each device comprises a channel equalizer and a monitoring device, wherein the channel equalizer is configured to continuously adapt to characteristics of the associated network cable by continuous training of the channel equalizer to help maintain the point-to-point network connection, wherein the monitoring device is configured to monitor signals received from the associated network cable for out-of-range signals, to temporarily interrupt the continuous training of the channel equalizer when out-of-range signals are detected, and to resume the continuous training once the out-of-range signals are no longer detected without executing the initial training cycle again,
wherein each device is powered by a constant current or constant power drawn from the power sourcing equipment via the network cables,
wherein the method comprises:
adding or removing one of the devices from the network system, thereby adding or removing the current or power drawn by that device, which causes a disturbance in the signals the other devices receive from their associated network cables;
detecting the disturbance as out-of-range signals at the monitoring devices of the other devices;
temporarily interrupting the continuous training of the channel equalizers of the other devices in response to detecting the disturbance as out-of-range signals, and resuming the continuous training of the channel equalizers of the other devices once the out-of-range signals are no longer detected without executing the initial training cycle again.
